(19) United States
(12) Patent Application Publication
(10) Pub. No.: US 2021/0155879 A1
(43) Pub. Date: May 27, 2021

(54) Cleaning Compositions

(71) Applicant: Reckitt Benckiser Vanish B.V., Hoofddorp (NL)

(72) Inventors: Silvia Baldan, Mira (IT); Claudia Sorato, Mira (IT); Dora Zamuner, Mira (IT)

(21) Appl. No.: 16/310,302

(22) PCT Filed: Jun. 8, 2017
(86) PCT No.: PCT/GB2017/051662

§ 371 Date: Dec. 14, 2018

(30) Foreign Application Priority Data
Jun. 15, 2016 (GB) 1610405.1

(51) Int. Cl. C11D 3/42; C11D 11/00; C11D 1/72; C11D 3/395; C11D 3/28; C11D 3/26

(52) U.S. Cl. CPC C11D 3/42; C11D 11/0017; C11D 3/26; C11D 3/395; C11D 3/28; C11D 1/72

(57) ABSTRACT

A composition comprises a bleach and an optical brightener, wherein the optical brightener is selected from the substance class(es) of benzonitrile, benzoxazole, benzopyrazol as well as their derivatives and substituted compounds. The optical brightener is present in an amount of 0.001 to 1 wt %, e.g. 0.08 wt %. The composition comprises a nonionic surfactant in a ratio by weight to the optical brightener is from around 5:1 to 1000:1.

The present invention relates to a cleaning composition comprising an optical brightener and a bleach. Optical brighteners are common ingredients in fabric/laundry washing or cleaning agents. They are used to prevent/disguise discoloration of items being cleaned. This discoloration is commonly exhibited as a yellowing/greying of the item being cleaned and is particularly prevalent in light/white coloured items.

Optical brighteners operate by acting as a radiation absorber/emitter. Natural day light is adsorbed and then emitted with a blueish hue. This emitted light aids the overcoming of the discoloration issues.

It is an object of the present invention to provide an improved formulation comprising an optical brightener.

According to a first aspect of the present invention there is provided a composition comprising a bleach and an optical brightener.

According to a second aspect of the present invention there is provided the use of a composition comprising a bleach and an optical brightener as a pre-treatment composition in a laundry/fabric washing operation.

Preferably the optical brightener is present in an amount of 0.01 to 1 wt %, e.g. 0.25 wt % (for synthetic fibres) or 0.35 wt % optical brightener (for cotton fibres).

It is preferred that the optical brightener is selected from the substance class(es) of benzonitrile, benzoxazole, benzopyrazol as well as their derivatives and substituted compounds. Preferred compounds are shown below:—

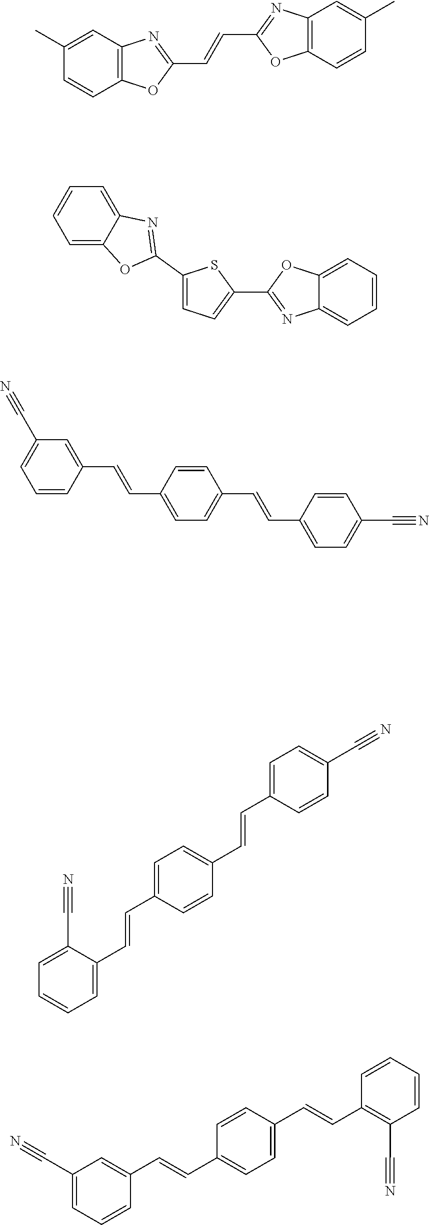

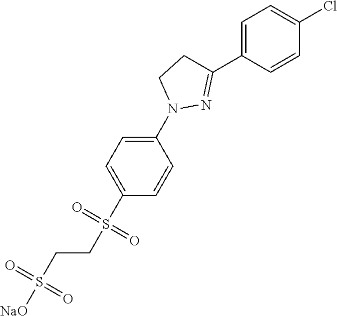

These compounds may be substituted.

The composition may additionally contain one or more supplementary optical brighteners. These may be present in an amount of from 0.01 to 10 wt %.

Preferred examples of these include stilbene brighteners. Stilbene brighteners are aromatic compounds with two aryl groups separated by an alkene chain. They preferably have the following structural formula: wherein R1 is hydrogen, halogen, alkyl, alkoxy or phenyl; R2 is hydrogen or alkyl;

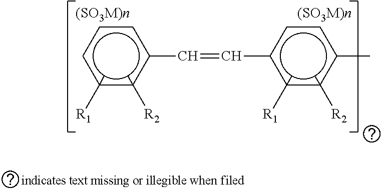

M is hydrogen, an alkali metal or ammonium ion; n=0-2, but the formula must contain at least one SO3 M group; and m=1-2 and when m=1, the substituent on the linkage carbon is hydrogen.

Especially suitable stilbene brighteners for use herein are described in U.S. Pat. Nos. 4,309,316, 4,298,490 and 5,035,825.

Bleach-stable anionic brighteners with sulfonic acid group(s) which work on cotton (cellulosics) are preferred.

The most preferred stilbene brighteners for use herein, because it is bleach-stable, is Tinopal@R CBS-X, which is benzenesulfonic acid, 2,2′((1,1′-biphenyl)-4,4′-diyldi-2,1-ethenediyl)bis-, disodium salt (CA Index Name). The formula for Tinopal@R CBS-X is below.

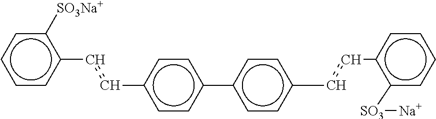

Another preferred stilbene brightener for use herein has the formula below.

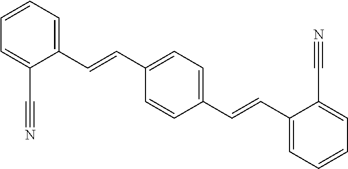 [SMILES: N#Cc1ccccc1/C=C/c1ccc(/C=C/c2ccccc2C#N)cc1]

Preferred examples of these include coumarin brighteners. They preferably have the following structural formula

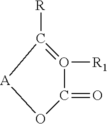

in which A represents an aromatic nucleus of which two vicinal carbon atoms form part of the unsaturated lactone ring, and which nucleus may contain substituents, R and R1 represent hydrogen or an alkyl, aryl or aralkyl radical, which may contain substituents.

Preferred examples of these include benzoxazole brighteners. They preferably have the following structural formula

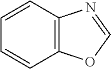

Preferred benzoxazoles have the formula below.

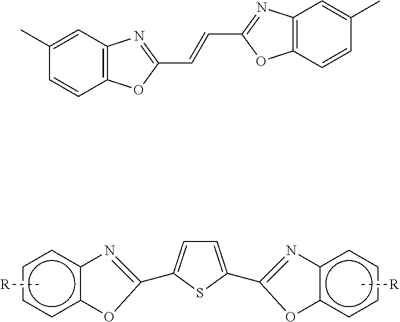

Other preferred compound include the following

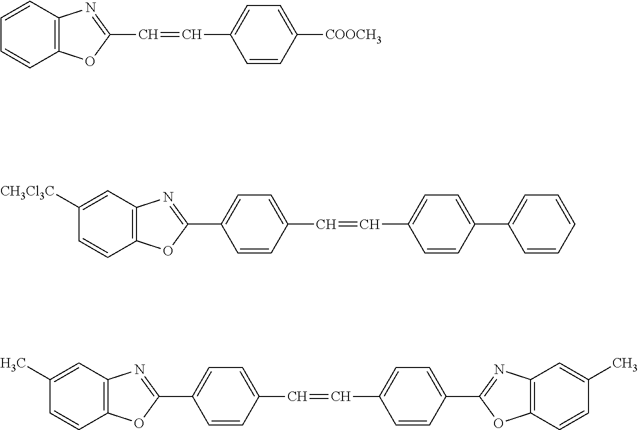

1,4-B is(4-cyanostyryl) benzene (CAS 13001-40-6);

### 2,5-Bis-2(5-Teri-Butyl-Benzoxalyl)thiophene (CAS 7128-64-5);

1,4-Bis(2-benzoxazolyl)naphthalene (CAS 5089-22-5);
2-[4-[4-(2-benzoxazolyl)styryl]phenyl]-5-methylbenzoxazole (CAS 5242-49-9)
4,4′-Bis(2-methoxystyryl)biphenyl (CAS 40470-68-6)
4,4′-Bis(2-benzoxazolyl)stilbene (CAS 1533-45-5)
2-[2-[4-[2-(3-cyanophenyl)vinyl]phenyl]vinyl]benzonitrile (CAS 79026-03-2)

Surprisingly, it has been found that the composition and use of the present invention have improved performance in stain treatment when used in a fabric/laundry cleaning operation. Furthermore this is achieved whilst avoiding the problem of “white halos/spotting” which typically occurs with local applications of optical brighteners on items being cleaned resulting in areas of the item having a different shade of white. Without wishing to be bound by theory it is postulated that this enhanced performance arises due to the ability of the optical brightener to camouflage any remnants of the stain in the stain treatment step.

Extremely surprising is the observation that the optical brightener works at low temperatures such as those experienced in a domestic laundry wash cycle (generally lower than 90° C., lower than 60° C., lower than 40° C., lower than 30° C. and often lower than 20° C.). This has been found to be surprising since some of the materials named above are used in textile finishing processes (especially for synthetic fabrics such as polyesters). In these finishes processed the fabrics are processed at a temperature of over 120° C. and often at a temperature as high as 180° C. It is believed that in this conventional finishing process such a high temperature is needed to bring the material I to its glass transition temperature so that it can interact with the optical brightener. Thus it is unexpected that the optical brightener can interact with a fabric (such as polyester) at the low temperatures (see above) of a domestic laundry operation.

It is reasoned that this interaction is aided by the presence of a nonionc surfactant. It is thought that the nonionc surfactant aids the solubility of the optical brightener into the wash liquor. Further it is postulated that the nonionic surfactant aids the bonding of the optical brightener with the fabric surface; which in the case of many fibres (such as polyester) is hydrophobic.

The surfactant is, for example, an anionic or nonionic surfactant or mixture thereof. The nonionic surfactant is preferably a surfactant having a formula RO(CH₂CH₂O)ₙH wherein R is a mixture of linear, even carbon-number hydrocarbon chains ranging from C₁₂H₂₅ to C₁₆H₃₃ and n represents the number of repeating units and is a number of from about 1 to about 12. Examples of other non-ionic surfactants include higher aliphatic primary alcohol containing about twelve to about 16 carbon atoms which are condensed with about three to thirteen moles of ethylene oxide.

Other examples of nonionic surfactants include primary alcohol ethoxylates (available under the Neodol trade name from Shell Co.), such as C₁₁ alkanol condensed with 9 moles of ethylene oxide (Neodol 1-9), C₁₂₋₁₃ alkanol condensed with 6.5 moles ethylene oxide (Neodol 23-6.5), C₁₂₋₁₃ alkanol with 9 moles of ethylene oxide (Neodol 23-9), C₁₂₋₁₅ alkanol condensed with 7 or 3 moles ethylene oxide (Neodol 25-7 or Neodol 25-3), C₁₉₋₁₅ alkanol condensed with 13 moles ethylene oxide (Neodol 45-13), C_{9_11} linear ethoxylated alcohol, averaging 2.5 moles of ethylene oxide per mole of alcohol (Neodol 91-2.5), and the like.

Other examples of nonionic surfactants suitable for use in the present invention include ethylene oxide condensate products of secondary aliphatic alcohols containing 11 to 18 carbon atoms in a straight or branched chain configuration condensed with 5 to 30 moles of ethylene oxide. Examples of commercially available non-ionic detergents of the foregoing type are C₁₁₋₁₅ secondary alkanol condensed with either 9 moles of ethylene oxide (Tergitol 15-S-9) or 12 moles of ethylene oxide (Tergitol 15-S-12) marketed by Union Carbide, a subsidiary of Dow Chemical.

Octylphenoxy polyethoxyethanol type nonionic surfactants, for example, Triton X-100, as well as amine oxides can also be used as a nonionic surfactant in the present invention. Other examples of linear primary alcohol ethoxylates are available under the Tomadol trade name such as, for example, Tomadol 1-7, a C₁₁ linear primary alcohol ethoxylate with 7 moles EO; Tomadol 25-7, a C₁₂-C₁₅ linear primary alcohol ethoxylate with 7 moles EO; Tomadol 45-7, a C₁₄-C₁₅ linear primary alcohol ethoxylate with 7 moles EO; and Tomadol 91-6, a C₉-C₁₁ linear alcohol ethoxylate with 6 moles EO.

Other examples of linear primary alcohol ethoxylates are available under the Lutensol trade name such as, for example, Lutensol A3N, a C₁₃₋₁₅ linear primary alcohol ethoxylate with 3 moles EO; Lutensol LA60, a C₁₃₋₁₅ linear primary alcohol ethoxylate with 7 moles EO. Also Genapol such as, for example, Genapol LA3, a C₁₃₋₁₅ linear primary alcohol ethoxylate with 3 moles EO; Genapol LA070, a C₁₃₋₁₅ linear primary alcohol ethoxylate with 7 moles EO Tomadol 45-7, a C₁₄₋₁₅ linear primary alcohol ethoxylate with 7 moles EO; and Tomadol 91-6, a C₉₋₁₁ linear alcohol ethoxylate with 6 moles E0.

Other Nonionic Surfactants are Amine Oxides, Alkyl Amide Oxide Surfactants.

Preferably the ratio of the nonionc surfactant to the optical brightener is around from 1-1000:1. This ratio may be around 10:1 fora powder formulation and 600:1 fora liquid formulation.

Preferred nonionic surfactants include alcohol ethoxylates with short (C1-C10) EO (and or PO/BO) chains.

Preferably the fabric treatment composition comprises a surfactant. Where present the composition comprises from 0.001% to 99.99%, preferably 0.05% to 15%, e.g. about 10%, by weight of surfactants. The composition may include other surfactants.

Preferred anionic surfactants are frequently provided as alkali metal salts, ammonium salts, amine salts, aminoalcohol salts or magnesium salts. Contemplated as useful are one or more sulfate or sulfonate compounds including: alkyl benzene sulfates, alkyl sulfates, alkyl ether sulfates, alkylamidoether sulfates, alkylaryl polyether sulfates, monoglyceride sulfates, alkylsulfonates, alkylamide sulfonates, alkylarylsulfonates, olefinsulfonates, paraffin sulfonates, alkyl sulfosuccinates, alkyl ether sulfosuccinates, alkylamide sulfosuccinates, alkyl sulfosuccinamate, alkyl sulfoacetates, alkyl phosphates, alkyl ether phosphates, acyl sarconsinates, acyl isethionates, and N-acyl taurates. Generally, the alkyl or acyl radical in these various compounds comprise a carbon chain containing 12 to 20 carbon atoms.

Other surfactants which may be used are alkyl naphthalene sulfonates and acyl/oleoyl sarcosinates and mixtures thereof.

Preferably the fabric treatment composition comprises a bleach. Where present the composition comprises from 0.001% to 99.99%, preferably 0.001% to 7%, preferably 2% to 6%, most preferably about 7%, by weight, of bleach. The bleach is preferably peroxide bleach, most preferably hydrogen peroxide. Peroxide sources other than H₂O₂ can be used.

Preferably the fabric treatment composition comprises a solvent. Where present the composition comprises from 0% to 99.99% preferably from 0% to 10% by weight, of solvent. The solvent constituent may comprise one or more alcohol, glycol, acetate, ether acetate or glycol ether. Exemplary alcohols useful in the compositions of the invention include C₂₋₈ primary and secondary alcohols which may be straight chained or branched, preferably pentanol and hexanol. More preferably the solvent is a glycol ether. Preferred examples of glycol ethers include glycol ethers having the general structure Ra—O—Rb—OH, wherein Ra is an alkoxy of 1 to 20 carbon atoms, or aryloxy of at least 6 carbon atoms, and Rb is an ether condensate of propylene glycol and/or ethylene glycol having from 1 to 10 glycol monomer units. Preferred are glycol ethers having 1 to 5 glycol monomer units.

Specific and preferred solvents are selected from propylene glycol methyl ether, dipropylene glycol methyl ether, dipropylene glycol propyl ether, dipropylene glycol butyl ether, tripropylene glycol methyl ether, propylene glycol n-propyl ether, ethylene glycol n-butyl ether, diethylene glycol n-butyl ether, diethylene glycol methyl ether, propylene glycol, ethylene glycol, isopropanol, ethanol, methanol, diethylene glycol monoethyl ether acetate, and particularly useful are, propylene glycol phenyl ether, ethylene glycol hexyl ether and diethylene glycol hexyl ether.

Most preferably the solvent or mixture of solvent is from the propanol series (Dowanol P-series) and among these Dipropylene Glycol n-Propyl Ether, Dipropylene Glycol n-Butyl Ether and Propylene Glycol Phenyl Ether. These are commercially available from Dow Chemicals as Dowanol DPnP, Dowanol DPnB and Dowanol PPH respectively.

Other useful solvents are hydrotropes such as sodium toluene sulfonate and sodium cumene sulfonate, short-chain alcohols such as ethanol and isopropanol, and the like. They can be present in the compositions as only solvents or in combination with other solvents.

Preferably the fabric treatment composition comprises a builder. Where present the composition comprises from 0% to 99.99% preferably from 0% to 10% by weight, of builder. The fabric treatment composition may comprise minor amounts of various optional ingredients, including enzymes (such as proteases, amylases, lipases and/or cellulases) in an amount of 0.001 to 1 wt %, dye transfer inhibition agents, dye catchers, preservatives, antistatic agents, fragrances, odour absorbing components. The pH range of the fabric treatment composition is typically from about 3 to about 8, preferably about 3.5.

The composition is most preferably suitable for discharge/application onto an item being cleaned using a spray device. Indeed in a preferred embodiment of the second aspect of the invention a spray device is employed.

Such application typically occurs before the item is washed in an automatic washing machine, i.e. the composition is used as pre-treater. In this application it is most noticeable that the problem of white halos/spotting is avoided.

The spray device may comprise a propellant and thus be in the form of an aerosol type device, wherein the pressure of the propellant is used to aid the discharge of the contents of the spray device when the spray device is activated. Alternatively the spray device may be manually operated and thus be in the form of a trigger spray device. In these device application of pressure to an operating lever causes the operation of a pump which brings about dispense of the contents of the spray device.

The invention is now described with reference to the following non-limiting Examples. Preferred Examples of formulae are as follows:

### Liquid

| WATER | To 100 |
|---|---|
| BHT | 0.025 |
| FRAGRANCE | 0.5 |
| C12-C16 ALCOHOLS 3EO | 3 |
| ALKYLETHOXYLATE C12-14, 7EO | 8 |
| SULPHONIC ACID | 7 |
| HEDP L | 0.2 |
| HYDROGEN PEROXIDE | 9 |
| OXALC(12/15, 13/15, 14/16) + 4-5EO | 0.5 |
| ANIONIC POLYURETHANE | 0.5 |
| PEARLIZER MIX | 0.3 |
| OPACIFIER | 0.1 |
| NON IONIC (EO/PO) RA30 | 0.5 |
| Optical brightener Stilbene derivative | 0.01-0.2 |
| Optical Brightener (preferred compound) | 0.001-1.00 |
| TOTAL | 100 |

### Powder

| | |
|---|---|
| Na Percarbonate | 40-50 |
| Na Carbonate heavy | Up to 25 |
| Na Sulphate | 0-15 |
| Carboxymethyl Cellulose 70% | 0.5 |
| Oxo Alcohols 4-5 EO | 0.5 |
| Linear Alkyll Benzene Sulfonate | 0-8.0 |
| Zeolite | 0.5 |
| Protease enzyme | 0.1-1.% |
| Amylase enzyme | 0.01-0.1% |
| Mannanase enzyme | 0.005 |
| Lipase enzyme | 0.028-0.5% |
| Cellulase enzyme | 0.001-1% |
| Disilicate | 1.2 |
| TAED white | 0-4 |
| Linear sodium Alkylbenzene Sulphonate | 0.6 |
| Fragrance | 0.3 |
| Optical brightener Stilbene derivative | 0.01-0.35 |
| Optical Brightener (preferred compound) | 0.001-1.00 |
| TOTAL | 100 |

Products tested:

| | | | | | | | | Dosage |
|---|---|---|---|---|---|---|---|---|
| | Products | | | OBA | Dosages | | | instructions |
| Leg1 | Dash | | | | CAS | 65 gr | | In wash |
| | Simply | | | | | | | |
| | Powder | | | | | | | |
| Leg2 | Dash | + | Vanish | Current | 27344- | 65 gr | 60 gr | In wash |
| | Simply | | White | Tinopal | 41-8 | | | |
| | Powder | | Gold | CBS-X | | | | |
| | | | Powder | | | | | |
| Leg3 | Dash | + | Vanish | +Uvitex | 79026- | 65 gr | 60 gr | In wash |
| | Simply | | White | SC-PB | 03-2 | | | |
| | Powder | | Gold | 0.1% | | | | |
| | | | Powder | | | | | |
| Leg4 | Dash | + | Vanish | +Uvitex | 79026- | 65 gr | 60 gr | In wash |
| | Simply | | White | SC-PR | 02-1 | | | |
| | Powder | | Gold | 0.1% | | | | |
| | | | Powder | | | | | |
| Leg5 | Dash | + | Vanish | +Hostalux | 27441- | 65 gr | 60 gr | In wash |
| | Simply | | White | PR P | 70-9 | | | |
| | Powder | | Gold | 0.1% | | | | |
| | | | Powder | | | | | |

Test Conditions

| | |
|---|---|
| Washing machine | Miele Novotronic W506 |
| Type of load | Front |
| Max. Load | 5 Kg |
| Used Load | 3.5 Kg Cotton total |
| Wash cycle | Cotton |
| Wash temperature | 40° C. |
| Water hardness | 28 ± 1° F. |
| External replications | 1 |
| Internal replications | 1/2 |
| No of laundering cycles | 1, 5, 10, 20 |
| Soil ballast | no |

Fabrics tested
Standard textiles:
   WFK20A: 65% pes/35% cotton
   WFK30A: 100% pes
New Textiles provided by tessport
   3 polyesters & 1 polyamide, different textures

### Evaluations:

Instrumental via spectrophotometer 650: Ganz Value (means of 4 readings)

### Whitening Performance Test Results

### Standard Textiles—Instrumental Evaluation

| | | | +Vanish White Powder | | | |
|---|---|---|---|---|---|---|
| | | Dash | Stilbene | Huntsman | Benzonitrile | Benzopyrazole |
| | | Simply | CAS | CAS | CAS | CAS |
| Ganz Value | | Powder | 27344-41-8 | 79026-03-2 | 79026-02-1 | 27441-70-9 |
| Wfk 30A | Cycle | alone | Tinopal CBS-X | Uvitex SC PB | Uvitex SC PR | Hostalux PR |
| 100% | 1 | 87 | 88 | 91 | 91 | 89 |
| polyester | 5 | 90 | 90 | 98 | 96 | 92 |
| | 10 | 91 | 94 | 109 | 103 | 96 |
| | 20 | 98 | 99 | 130 | 125 | 102 |

Uvitex exhibits significant improvement whitening performance vs Vanish Wing powder on pure polyester fiber
Hostalux gives some whitening improvement vs current Stilbene OBA

### Whitening Performance Test Results

### Tessport's New Synthetic Fabrics—Instrumental Evaluation

| | | | +Vanish | +Uvitex | +Uvitex | |
|---|---|---|---|---|---|---|
| GANZ Value | Cycle | Dash S. | Powder | PB | PR | +Hostalux |
| 100% | 1 | 89 | 90 | 92 | 93 | 90 |
| polyester | 5 | 90 | 92 | 106 | 100 | 93 |
| | 10 | 91 | 95 | 111 | 109 | 96 |
| | 20 | 94 | 99 | 128 | 122 | 100 |
| 100% | 1 | 87 | 88 | 90 | 89 | 87 |
| polyester | 5 | 89 | 90 | 99 | 96 | 89 |
| | 10 | 89 | 93 | 108 | 105 | 92 |
| | 20 | 91 | 93 | 119 | 116 | 92 |

Uvitex exhibits improved whitening performance vs Vanish Wing powder on polyester fabrics, based on instrumental evaluation

### Whitening Performance Test Results

### Tessport's New Synthetic Fabrics Instrumental Evaluation

| | | | +Vanish | +Uvitex | +Uvitex | |
|---|---|---|---|---|---|---|
| GANZ Value | Cycle | Dash S. | Powder | PB | PR | +Hostalux |
| 100% | 1 | 77 | 78 | 80 | 79 | 77 |
| Polyamide | 5 | 78 | 79 | 89 | 86 | 79 |
| | 10 | 79 | 82 | 97 | 94 | 82 |
| | 20 | 80 | 83 | 108 | 104 | 83 |
| 100% | 1 | 91 | 103 | 104 | 102 | 105 |
| Polyester | 5 | 106 | 123 | 125 | 124 | 124 |
| | 10 | 118 | 147 | 156 | 152 | 150 |
| | 20 | 139 | 171 | 177 | 179 | 173 |

Both Uvitex exhibit improved whitening performance vs Wing powder on polyamide and polyester fabrics, based on instrumental evaluation

### Whitening Performance for OBA in Liquid

### New Testing Protocol

| | | | | | Dosages | | |
|---|---|---|---|---|---|---|---|
| | | | | % raw | Detergent | Addittive | |
| Leg | Products Tested | | | material | (gr) | (ml) | Treatment |
| 1 | Dash Simply Powder+ | Vanish Gold White Gel | | | 65 | 120 | In Wash |
| 2 | Dash Simply Powder+ | Vanish Gold White Gel+ | Uvitex ERF = ERNP250% | 0.1 | 65 | 120 | In Wash |
| 3 | Dash Simply Powder+ | Vanish Gold White Gel+ | Optiblanc RGF 250% CAS 2866-43-5 | 0.1 | 65 | 120 | In Wash |
| 4 | Dash Simply Powder+ | Vanish Gold White Gel+ | Optiblanc RG1 200% CAS 1041-00-5 | 0.1 | 65 | 120 | In Wash |
| 5 | Dash Simply Powder+ | Vanish Gold White Gel+ | Zetablanc PES | 0.1 | 65 | 120 | In Wash |

### Test Conditions:

| | |
|---|---|
| Washing machine | Miele Novotronic W506 |
| Type of load | Front |
| Max. Load | 5 Kg |
| Used Load | 3.5 Kg Cotton total |
| Wash cycle | Cotton |
| Wash temperature | 40° C. |
| Water hardness | 28 ± 1° F. |
| External replications | 1 |
| Internal replications | 1/2 |
| No of laundering cycles | 1, 5, 10, 20 |
| Soil ballast | no |

### Whitening Performance Test Results

### Standard Textiles—Instrumental Evaluation

| | | Dash + | +Uvitex | +Optiblac | +Optiblac | +Zetablanc |
|---|---|---|---|---|---|---|
| Fabrics | Wash | Vanish L | ERF | RGF 250% | RG1 200% | PES |
| WFK 30A | 1 | 89 | 94 | 96 | 94 | 92 |
| 100% | 5 | 90 | 105 | 107 | 103 | 104 |
| polyester | 10 | 92 | 113 | 113 | 113 | 114 |
| | 20 | 97 | 120 | 123 | 123 | 120 |
| WFK 40A | 1 | 6 | 4 | 11 | 8 | 8 |
| 100% | 5 | 9 | 19 | 27 | 20 | 17 |
| polyammide | 10 | 12 | 34 | 36 | 33 | 31 |
| | 20 | 22 | 37 | 41 | 35 | 36 |
| Code 22/48 | 1 | 90 | 98 | 99 | 95 | 95 |
| 100% | 5 | 91 | 109 | 111 | 108 | 106 |
| POLYESTER | 10 | 94 | 118 | 118 | 117 | 117 |
| | 20 | 98 | 133 | 128 | 130 | 129 |

Good improvement in whitening performance of polyester and polyamide from all new OBA tested, after 5 washes

### Whitening Performance Test Results

### Tessport's New Synthetic Fabrics—Instrumental Evaluation

| | | Dash + | +Uvitex | +Optiblac | +Optiblac | +Zetablanc |
|---|---|---|---|---|---|---|
| Fabrics | Wash | Vanish L | ERF | RGF 250% | RG1 200% | PES |
| Code 33/72 | 1 | 89 | 94 | 95 | 94 | 93 |
| 100% | 5 | 90 | 103 | 107 | 103 | 101 |
| POLYESTER | 10 | 90 | 111 | 111 | 109 | 110 |
| | 20 | 93 | 121 | 119 | 121 | 119 |
| Code 85/96 | 1 | 79 | 82 | 84 | 83 | 82 |
| 100% | 5 | 78 | 91 | 95 | 91 | 90 |
| POLYESTERE | 10 | 81 | 100 | 100 | 98 | 99 |
| | 20 | 83 | 111 | 109 | 109 | 108 |
| Code 83/36 | 1 | 117 | 124 | 136 | 132 | 122 |
| 100% | 5 | 154 | 162 | 174 | 167 | 159 |
| POLYAMIDE | 10 | 171 | 180 | 187 | 182 | 178 |
| | 20 | 192 | 191 | 197 | 194 | 188 |

Good improvement in whitening performance of polyester and polyamide from all new OBA tested, after 5 washes

### Screening for OBA in Liquid

### Testing Protocol

| | | | Dosages | | |
|---|---|---|---|---|---|
| | | % raw | Detergent | Addittive | |
| Leg | Products Tested | material | (gr) | (ml) | Treatment |
| 1 | Dash Simply Powder + Vanish Gold White Gel | — | 65 | 120 | IW |
| 2 | Dash Simply Powder + Vanish Gold White Gel + Sera White C-MBN | 0.2 | 65 | 120 | IW |
| 3 | Dash Simply Powder + Vanish Gold White Gel + Uvitex ERF | 0.2 | 65 | 120 | IW |
| 4 | Dash Simply Powder + Vanish Gold White Gel + Optiblanc RGF 250% | 0.2 | 65 | 120 | IW |
| 5 | Dash Simply Powder + Vanish Gold White Gel + Optiblanc RG1 200% | 0.2 | 65 | 120 | IW |
| 6 | Dash Simply Powder + Vanish Gold White Gel + Zetablanc PES | 0.2 | 65 | 120 | IW |

### Test Conditions:

| | |
|---|---|
| Water hardness | 28° F. |
| Temperature | 60° C. |
| Washing machine | BOSCH |
| Wash cycle | Cotton program with Turbo option. 1000 rpm |
| Load and condition | 2.5 kg clean, POLYESTER ballast (RASO |
| | VARESE) |
| Repeated wash cycles | 1, 2, 3. |
| Replications | 1 external and 2 internals |
| Instr. Evaluation | Datacolor 650 Spectrophotometer |
| Drying and ironing | Test swatches were air dried and not ironed |

### Screening Test Results

### Standard Fabrics—Instrumental Evaluation (60° C.-0.2% OBA)

| | | Dash + | +Sera White | +Uvitex | +Optiblac | +Optiblac | +Zetablanc |
|---|---|---|---|---|---|---|---|
| Fabrics | Wash | Vanish L | C-MBN | ERF | RGF 250% | RG1 200% | PES |
| WFK 30A | 0 | 70 | | | | | |
| 100% | 1 | 72 | 80 | 93 | 95 | 87 | 87 |
| polyester | 2 | 74 | 80 | 104 | 108 | 95 | 93 |
| | 3 | 74 | 82 | 113 | 115 | 102 | 100 |
| WFK 40A | 0 | 6 | | | | | |
| 100% | 1 | 26 | 31 | 36 | 43 | 35 | 37 |
| polyamide | 2 | 25 | 22 | 36 | 48 | 34 | 34 |
| | 3 | 22 | 27 | 34 | 53 | 39 | 35 |
| Code 22/48 | 0 | 71 | | | | | |
| 100% | 1 | 75 | 88 | 104 | 114 | 97 | 95 |
| POLYESTER | 2 | 76 | 90 | 116 | 124 | 106 | 105 |
| | 3 | 76 | 92 | 126 | 130 | 114 | 113 |

Good improvement in whitening performance of polyester and polyamide from all new OBA tested, already after 1 wash

### Screening Test Results

### Standard Fabrics—Instrumental Evaluation (60° C.-0.2% OBA)

| | | Dash + | +Sera White | +Uvitex | +Optiblac | +Optiblac | +Zetablanc |
|---|---|---|---|---|---|---|---|
| Fabrics | Wash | Vanish L | C-MBN | ERF | RGF 250% | RG1 200% | PES |
| Ritex Test 13 | 0 | 70 | | | | | |
| POLYESTER | 1 | 72 | 82 | 94 | 102 | 88 | 88 |
| | 2 | 71 | 84 | 104 | 112 | 96 | 94 |
| | 3 | 72 | 82 | 113 | 118 | 104 | 100 |
| Rites Test 14 | 0 | 59 | | | | | |
| POLYAMMIDE | 1 | 62 | 75 | 90 | 99 | 82 | 82 |
| | 2 | 63 | 76 | 101 | 109 | 89 | 87 |
| | 3 | 63 | 78 | 109 | 114 | 99 | 97 |
| Ritex Test 15 | 0 | 61 | | | | | |
| POLYESTER | 1 | 142 | 144 | 151 | 144 | 149 | 147 |
| | 2 | 159 | 159 | 169 | 169 | 168 | 161 |
| | 3 | 171 | 171 | 178 | 178 | 175 | 173 |

Good improvement in whitening performance of polyester and polyamide from all new OBA tested

### Washing Test

Products and their Dosage:

| | | OBA | Dosages | |
|---|---|---|---|---|
| | | % raw | Detergent | Additive |
| Ref | | material | (gr) | (ml) |
| 1 | Dash Simply Powder | — | 65 | 120 |
| 2 | Dash Simply Powder + | 0.1 | 65 | 120 |
| | Vanish Gold White Gel + | | | |
| | Optiblanc RGF 250% | | | |

Treatment was in wash. Ref #1 was washed at 40° C. and Ref #2 at 20° C.

### Condition of Test

| | |
|---|---|
| Water hardness | 28° F. |
| Temperature | 40° C. LEG 1 |
| Temperature | 20° C. LEG 2 |
| Washing machine | Miele 6065 plus |
| Wash cycle | Cotton program 600 rpm |
| Load | see the list below |
| Repeated wash | |
| cycles | total 12 = 10 washes + 2 washes without rinse |
| Replications | 1 internal |
| Soil | SBL 2004 (1 sheet for wash after 3° washes) |
| Instr. Evaluation | Datacolor 650 Spectrophotometer |
| Drying and ironing | Test swatches were air dried and not ironed |

### Fabrics Type Used in Test

| APPAREL ITEMS | BRAND | SHOPS | TEXTILE COMPOSITION |
|---|---|---|---|
| LADY SHIRT | H&M | H&M AUCHAN | INTERNAL FABRIC: 100% POLYESTER, |
| | | MESTRE | EXTERNAL FABRIC: 100% POLYAMIDE |
| BRA | H&M | H&M AUCHAN | PIZZO: 84% POLYAMIDE, 15% ELASTANE, |
| | | MESTRE | 1% POLYESTER. RETE: 64% |
| | | | POLYAMIDE, 36% ELASTANE. |
| | | | FODERA COPPA: 100% POLYESTER. |
| | | | CODA: 82% POLYAMIDE, 18% ELASTANE |
| SWIMMING | H&M | H&M AUCHAN | EXTERNAL FABRIC: 95% POLYAMIDE, 5% |
| COSTUME | | MESTRE | ELASTANE. INTERNAL FABRIC: 92% |
| | | | POLYAMIDE, 8% ELASTANE |
| WOMAN'S | FASHION | SUPERMARKET | 84% POLYAMIDE, 16% ELASTANE |
| UNDERWEAR | EXPRESS | VALECENTER | |
| WOMAN'S | TEX | SUPERMARKET | 87% POLYAMIDE, 8% ELASTANE, 5% |
| UNDERWEAR | | VALECENTER | POLYESTERE |
| WOMAN'S | TEX | SUPERMARKET | 93% POLYAMIDE, 7% ELASTANE |
| UNDERWEAR | | VALECENTER | |

### Results

The higher the Ganz Index value the better the Whitening performance

| | | Dash Simply + |
|---|---|---|
| GANZ WHITENESS INDEX | Dash Simply | Vanish Wing Gel + |
| INSTRUMENTAL | Powder | OPTIBLANC RGF 250 |
| EVALUATION | 40° C. | 20° C. |
| LACE LADY SHIRT | 126 | 160 |
| SWIMMING COSTUME | 130 | 149 |
| H&M | | |
| LACE BRA H&M | 121 | 142 |
| LACE WOMAN | 158 | 172 |
| UNDERWEAR | | |
| WOMAN UNDERWEAR | 153 | 171 |
| WOMAN UNDERWEAR | 142 | 181 |

### CONCLUSIONS

Vanish White gel with Optiblanc RGF 250% delivers best and higher whitening performance at 20° C. washing in cold water vs the use of Laundry Detergent Powder at 40° C.

1. A composition comprising:
a bleach;
a nonionic surfactant; and
an optical brightener;
wherein the optical brightener is selected from the group consisting of benzonitrile, benzoxazole, benzopyrazole, their derivatives and substituted compounds;
wherein the optical brightener is present in an amount of from 0.001 to 1 wt % of the composition; and
wherein the nonionic surfactant is present in a ratio by weight to the optical brightener from around 5:1 to 1000:1.

2. The composition according to claim 1, wherein the optical brightener comprises the following compound:

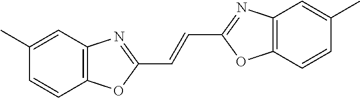

3. A method comprising washing fabric in the presence of an amount of the composition of claim 1.

4. The method according to claim 4, wherein the fabric comprises a synthetic material.

5. The composition according to claim 1, wherein the optical brightener comprises the following compound:

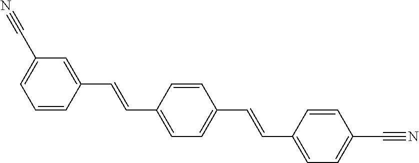 [SMILES: N#Cc1ccc(/C=C/c2ccc(/C=C/c3cccc(C#N)c3)cc2)cc1]

6. The composition according to claim 1, wherein the optical brightener comprises the following compound:

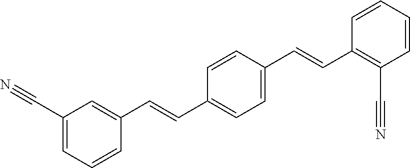 [SMILES: N#Cc1cccc(/C=C/c2ccc(/C=C/c3ccccc3C#N)cc2)c1]

7. The composition according to claim 1, wherein the optical brightener comprises the following compound:

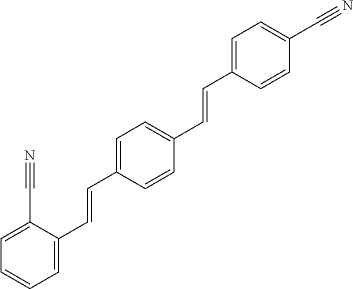 [SMILES: N#Cc1ccc(/C=C/c2ccc(/C=C/c3ccccc3C#N)cc2)cc1]

8. The method according to claim 4, wherein the synthetic material is selected from the group consisting of polyamide and polyester.

9. A composition comprising:
a bleach;
a nonionic surfactant; and
a first optical brightener;
wherein the optical brightener is present in an amount of from approximately 0.001 to approximately 1 wt % of the composition; and
wherein the nonionic surfactant is present in a ratio by weight to the optical brightener from approximately 5:1 to approximately 1000:1.

10. The composition according to claim 9 further comprising a second optical brightener different than the first optical brightener, the second optical brightener comprising a stilbene brightener.

11. The composition according to claim 10, wherein the first optical brightener is selected from the group consisting of benzonitrile, benzoxazole, benzopyrazole, their derivatives and substituted compounds.

12. The method according to claim 3, wherein washing the fabric occurs at a temperature of less than approximately 90° C.

13. The method according to claim 3, wherein washing the fabric occurs at a temperature of less than approximately 60° C.

14. The method according to claim 3, wherein washing the fabric occurs at a temperature of less than approximately 40° C.

15. The method according to claim 3, wherein washing the fabric occurs at a temperature of less than approximately 30° C.

16. The method according to claim 3, wherein washing the fabric occurs at a temperature of less than approximately 20° C.
